(19) United States
(12) Patent Application Publication
(10) Pub. No.: US 2024/0196428 A1
(43) Pub. Date: Jun. 13, 2024

(54) LOGICAL CHANNEL PRIORITY RANKING METHOD AND APPARATUS, DEVICE AND STORAGE MEDIUM

(71) Applicant: GUANGDONG OPPO MOBILE TELECOMMUNICATIONS CORP., LTD., Dongguan (CN)

(72) Inventors: Boyuan ZHANG, Dongguan (CN); Qianxi Lu, Dongguan (CN); Bingxue Leng, Dongguan (CN)

(73) Assignee: GUANGDONG OPPO MOBILE TELECOMMUNICATIONS CORP., LTD., Dongguan (CN)

(21) Appl. No.: 18/587,490

(22) Filed: Feb. 26, 2024

Related U.S. Application Data
(63) Continuation of application No. PCT/CN2021/123135, filed on Oct. 11, 2021.

(51) Int. Cl. H04W 72/566; H04W 72/51; H04W 76/14

(52) U.S. Cl. CPC H04W 72/566; H04W 72/51; H04W 76/14

(57) ABSTRACT

Provided are a method and apparatus for logical channel priority ranking, a device and a storage medium, which relate to the technical field of communications. The method includes: based on a configuration of a transmission resource pool, performing by a terminal a logical channel priority ranking operation on an available resource selected from the transmission resource pool, the transmission resource pool including a resource pool for sending a sidelink discovery message and/or a resource pool for sidelink data.

### CROSS-REFERENCE TO RELATED APPLICATION

This application is a continuation application of International Patent Application No. PCT/CN2021/123135 filed on Oct. 11, 2021, the entire contents of which are incorporated herein by reference.

### TECHNICAL FIELD

The disclosure relates to the technical field of communications, and particularly to a method and apparatus for prioritizing logical channels, a device, and a storage medium.

### BACKGROUND

In a sidelink (SL), to implement direct communication between two terminals, a first terminal generally is required to send a discovery message to a second terminal, and the two terminals may perform communication with each other after the second terminal sends a feedback to the discovery message.

In related art, for sending the discovery message, a medium access control (MAC) entity of the first terminal is required to prioritize logical channels.

### SUMMARY

Embodiments of the disclosure provide a method and apparatus for prioritizing logical channels, a device, and a storage medium, enabling a terminal to perform logical channel prioritization corresponding to different configurations of a transmission resource pool. A technical solution herein is as follows.

An aspect of the disclosure provides a method for prioritizing logical channels. The method includes operations as follows.

A terminal performs, based on a configuration of a transmission resource pool, logical channel prioritization on an available resource selected from the transmission resource pool.

The transmission resource pool includes at least one of: a resource pool configured for sending a discovery message for a sidelink, or a resource pool for sidelink data.

An aspect of the disclosure provides an apparatus for prioritizing logical channels. The apparatus includes a selecting module.

The selecting module is configured to perform, based on a configuration of a transmission resource pool, logical channel prioritization on an available resource selected from the transmission resource pool.

The transmission resource pool includes at least one of: a resource pool configured for sending a discovery message for a sidelink, or a resource pool for sidelink data.

An aspect of the disclosure provides a terminal. The terminal includes a processor.

The processor is configured to perform, based on a configuration of a transmission resource pool, logical channel prioritization on an available resource selected from the transmission resource pool.

The transmission resource pool includes at least one of: a resource pool configured for sending a discovery message for a sidelink, or a resource pool for sidelink data.

An aspect of the disclosure provides a computer-readable storage medium. The storage medium has stored thereon a computer program. The computer program is configured to be executed by a processor to implement the foregoing method for prioritizing logical channels.

An aspect of the disclosure provides a chip. The chip includes at least one of a programmable logic circuit or program instructions configured to implement the foregoing method for prioritizing logical channels when the chip runs.

An aspect of the disclosure provides a computer program product or a computer program. The computer program product or the computer program includes computer instructions stored in a computer-readable storage medium which, when read and executed by a processor, implement the foregoing method for prioritizing logical channels.

A technical solution of embodiments of the disclosure has at least beneficial effects as follows.

A terminal is enabled to perform logical channel prioritization corresponding to different configurations of a transmission resource pool. The transmission resource pool includes a resource pool for sending sidelink data and/or a discovery message of a sidelink.

### BRIEF DESCRIPTION OF THE DRAWINGS

Drawings used in describing embodiments of the disclosure are introduced briefly for clearer illustration of a technical solution in the embodiments. Note that the drawings described hereinafter refer merely to some embodiments of the disclosure. A person having ordinary skill in the art may acquire other drawings according to the drawings herein without creative effort.

FIG. 1 is a diagram of a structure of a sidelink communication system according to an illustrative embodiment of the disclosure.

FIG. 2 is a flowchart of a method for prioritizing logical channels according to an illustrative embodiment of the disclosure.

FIG. 3 is a flowchart of a method for prioritizing logical channels according to an illustrative embodiment of the disclosure.

FIG. 4 is a flowchart of a method for prioritizing logical channels according to an illustrative embodiment of the disclosure.

FIG. 5 is a flowchart of a method for prioritizing logical channels according to an illustrative embodiment of the disclosure.

FIG. 6 is a flowchart of a method for prioritizing logical channels according to an illustrative embodiment of the disclosure.

FIG. 7 is a flowchart of a method for prioritizing logical channels according to an illustrative embodiment of the disclosure.

FIG. 8 is a diagram of multi-end interaction in a method for prioritizing logical channels according to an illustrative embodiment of the disclosure.

FIG. 9 is a diagram of an apparatus for prioritizing logical channels according to an illustrative embodiment of the disclosure.

FIG. 10 is a diagram of a structure of a communication device according to an illustrative embodiment of the disclosure.

### DETAILED DESCRIPTION

To make an object, a technical solution, and beneficial effects of the disclosure clearer, implementation of the disclosure is further elaborated hereinafter with reference to the drawings. Clearly, embodiments described herein are some, instead of all, embodiments of the disclosure. Based on the embodiments of the disclosure, a person having ordinary skill in the art may acquire another embodiment without creative effort. Any such embodiment falls within the scope of the disclosure.

A technical solution according to embodiments of the disclosure may apply to various communication systems, such as a global system of mobile communication (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved NR system, a LTE-based access to unlicensed spectrum (LTE-U) system, a NR-based access to unlicensed spectrum (NR-U) system, a non-terrestrial networks (NTN) system, a universal mobile telecommunication system (UMTS), wireless local area networks (WLAN), wireless fidelity (WiFi), a 5th-generation (5G) system, or another communication system, etc.

In general, a conventional communication system supports a limited number of connections, which are also easy to achieve. However, with development of communication technology, in addition to supporting conventional communication, a mobile communication system also has to support device to device (D2D) communication, machine to machine (M2M) communication, machine type communication (MTC), vehicle to vehicle (V2V) communication, or vehicle to everything (V2X) communication, etc., for example. Embodiments of the disclosure may also apply to these communication systems.

In an example, a communication system in embodiments of the disclosure apply to a carrier aggregation (CA) scene, a dual connectivity (DC) scene, as well as a standalone (SA) networking scene.

In an example, a communication system in embodiments of the disclosure apply to an unlicensed spectrum. An unlicensed spectrum may also be deemed as a shared spectrum. Alternatively, a communication system in embodiments of the disclosure may also apply to a licensed spectrum. A licensed spectrum may also be deemed as an unshared spectrum.

Embodiments of the disclosure describe each embodiment with reference to a network device as well as a terminal. A terminal may also be referred to as a user equipment (UE), an access terminal, a user unit, a user station, a mobile station, a remote station, a remote terminal, a mobile device, a user terminal, a terminal device, a wireless communication device, a user agent, or a user apparatus, etc.

A terminal may be a station (ST) in WLAN, and may be a cell phone, a cordless phone, a session initiation protocol (SIP) phone, a wireless local loop (WLL) station, a personal digital assistant (PDA) device, a handheld device capable of radio communication, a computing device, or another processing device connected to a radio modem, an onboard device, a wearable device, a terminal device in a next-generation communication system such as a NR network, or a terminal device in a future evolved public land mobile network (PLMN), etc.

In embodiments of the disclosure, a terminal may be deployed on land, such as indoor or outdoor, handheld, wearable, or onboard; on water (such as a ship, etc.); and may also be airborne such as onboard an aircraft, a balloon, a satellite, etc.

In embodiments of the disclosure, a terminal may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal device in a smart home, etc.

Illustratively but not limitingly, in embodiments of the disclosure, the terminal may be further a wearable equipment. A wearable equipment may also be referred to as a wearable smart equipment, and is a blanket term for wearable equipment developed by applying intelligent design to everyday wear using wearable technology, such as glasses, gloves, watches, clothing, shoes, etc. A wearable equipment is a portable equipment direct worn by a user, or integrated to clothes or an accessory of the user. A wearable equipment not only may be a hardware equipment, but also may implement a powerful function through software support, data exchange, cloud exchange, etc. A wearable smart equipment in general may include one with comprehensive functions, being large-sized, and implementing all or some of the functions independent of any smart mobile phone, such as a smart watch, smart glasses, etc., and one that focuses on just a certain application function and that has to be used together with another equipment such as a smart mobile phone, such as various smart bracelets, smart jewelry for monitoring a physical sign, etc.

In embodiments of the disclosure, a network device is configured to communicate with a mobile device. A network device may be an access point (AP) in WLAN, a base transceiver station (BTS) in GSM or CDMA, a node B (NB) in WCDMA, an evolutional node B (eNB or eNodeB) in LTE, or a relay or an AP, or an onboard device, a wearable device as well as a network device or a base station (next generation NodeB, gNB) in a NR network or a network device in a future evolved PLMN or a network device in an NTN network, etc.

Illustratively but not limitingly, in embodiments of the disclosure, a network device may have mobile characteristics. For example, a network device may be a mobile device. In an example, a network device may be a satellite, a balloon station, etc. For example, the satellite may be a low earth orbit (LEO) satellite, a medium earth orbit (MEO) satellite, a geostationary earth orbit (GEO) satellite, a high elliptical orbit (HEO) satellite, etc. In an example, a network device may be further a base station provided at a location such as on land, on water, etc.

In embodiments of the disclosure, a network device may provide a cell with a service. A terminal may perform communication with the network device through a transmission resource used in the cell (such as the frequency resource, or a spectrum resource). The cell may be a cell corresponding to the network device (such as a BTS). The cell may belong to a macro BTS, or to a BTS corresponding to a small cell. Here, a small cell may include a metro cell, a micro cell, a pico cell, a femto cell, etc. Such a small cell may have a small coverage and a low transmit power, and be suitable for providing a data transmission service of a high rate.

Understandably, terms “system” and network” in the disclosure are often interchangeable in usage. The term “and/or” in the disclosure describes just an association between associated objects, including three possible relationships. For example, by A and/or B, it may mean that there may be three cases, namely, existence of A, existence of both A and B, and existence of B. A slash mark “/” in the disclosure generally represents an “or” relationship between two associated objects that come respectively before and after the mark per se.

A term used in detailed description of the disclosure is for explaining embodiments of the disclosure rather than limiting the disclosure. A term such as “first”, “second”, “third”, “fourth”, etc., in the specification, the claims, and the drawings of the disclosure is just for differentiating different objects, instead of denoting any specific order. In addition, a term such as “including/comprising”, “having”, or any other variant of the term is intended to cover a non-exclusive inclusion.

Understandably, “indication/indicate” mentioned in embodiments of the disclosure may refer to direct indication or indirect indication, and may also mean an association relation. For example, by saying that A indicates B, it may mean that A indicates B directly, for example, B may be acquired through A; it may mean that A indicates B indirectly, for example, A indicates C and B may be acquired through C; or it may mean an association relation between A and B.

In describing an embodiment of the disclosure, the term “corresponding” may mean a direct correspondence or an indirect correspondence between two items, an association between the two, or a relation of indicating and being indicated, configuring and being configured, etc.

In embodiments of the disclosure, “predefining” may be achieved by saving a corresponding code and/or a table beforehand in a device (including a terminal and a network device, for example), or in another manner that may be configured to indicate related information, the specific implementation of which is not limited in embodiments of the disclosure. For example, “predefined” may be as defined in a protocol.

In embodiments of the disclosure, a protocol may refer to a standard protocol in the field of communications, and may include, for example, an LTE protocol, a NR protocol, and a related protocol applying to a future communication system, which is not limited in embodiments of the disclosure.

Knowledge relevant to the disclosure is first described hereinafter before introducing a technical solution of the disclosure.

### LTE D2D/V2X

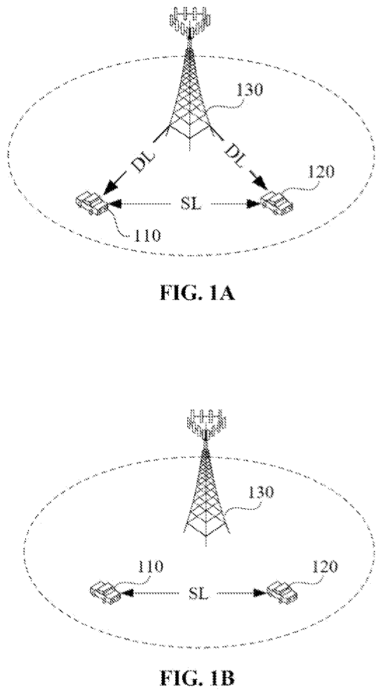

D2D communication is a D2D based sidelink (SL) transmission technology. Unlike a mode adopted in a conventional cellular system where communication data is received or sent through a base station, a device to device direct communication is adopted in a V2X system, so that an increased spectral efficiency and a decreased transmission latency are achieved. FIG. 1 illustrates a diagram of a structure of a sidelink communication system according to an illustrative embodiment of the disclosure. The sidelink communication system includes a first terminal 110, a second terminal 120, and a network device 130. Two modes of sidelink communication, mode 1 and mode 2, are defined in a 3rd generation partnership project (3GPP).

As illustrated in FIG. 1A, in mode 1, the network device 130 allocates transmission resources to the first terminal 110 and the second terminal 120, the first terminal 110 and the second terminal 120 respectively send data on a sidelink based on the resources allocated by the network device 130. The network device 130 may allocate resources for single transmission or semi-static transmission to the first terminal 110 and the second terminal 120.

As illustrated in FIG. 1B, in mode 2, the first terminal 110 and the second terminal 120 respectively select a resource from a resource pool to perform data transmission.

In the 3GPP, research is made for different D2D stages.

For proximity based service (ProSe), illustratively, research is done on D2D communication for a ProSe scene, which is mainly for public safety services.

In ProSe, by configuring time-domain locations for a resource pool, such as making the resource pool discontinuous in time domain, a terminal can send/receive data discontinuously on a sidelink, thereby saving power.

Research is done on vehicle to vehicle communication in a V2X system, which is oriented mainly toward services of communication between a vehicle and a person or between vehicles at a relatively high speed. In V2X communication, a dominating issue is data transmission latency instead of power efficiency, as an onboard system is powered continually. Therefore, the system design requires a terminal to perform continuous transmission and reception.

In related art, research is done on a scene where a wearable device (FeD2D) accesses a network through a mobile phone, which is oriented mainly toward slow movement and low power access.

A 3GPP pre-research conclusion for the FeD2D is that a network device may configure, through a relay terminal, a discontinuous reception (DRX) parameter for a remote terminal, with yet any conclusion as to specifics of the DRX configuration.

In related art, a multi-carrier mechanism is introduced in LTE V2X communication. Illustratively, the multi-carrier mechanism manifests itself in the capability of a terminal to support packet segmentation for which a packet is transmitted by multiple carriers to improve a data transmission rate and to support packet duplication for which two copies of a same packet are made and are sent by two carriers to improve transmission reliability, as well as in enhanced multi-carrier reception at a receiving end. Illustratively, for packet duplication, V2X sidelink communication supports sidelink packet duplication, which is implemented at a packet data convergence protocol (PDCP) layer of a terminal. For sidelink packet duplication for transmission, a PDCP packet data unit (PDU) is duplicated at a PDCP entity. PDCP PDU copies of the same PDCP entity are sent to two different radio link control (RLC) entities and are respectively associated to two different sidelink logical channels. PDCP PDU copies of the same PDCP entity are allowed to be transmitted on different sidelink carriers only. A terminal may enable or disable sidelink packet duplication based on a (pre)configuration. A ProSe per-packet reliability (PPPR) value in ProSe supporting sidelink packet duplication may be (pre)configured through a PPPR threshold. For autonomous resource selection and scheduled resource allocation of the terminal, the terminal shall perform sidelink packet duplication on data configured with PPPR values, until packet duplication configuration for the PPPR values is canceled. For scheduled resource allocation, the terminal may report, through a sidelink buffer status report (BSR), quantity of data associated to one or more PPPR values and a destination of the data. Mapping of a PPPR value to a logical channel group may be configured by the network device, and the PPPR value may be represented by an associated logical channel group ID included in the sidelink BSR. A list of one or more PPPR values may be reported through sidelink terminal information by a radio resource control (RRC) connected UE.

### Relay Discovery

There are several cases as follows as to a relay terminal for relay between a terminal and a network device.

Before a relay terminal in a radio resource control (RRC) idle status or an RRC inactive status may send a discovery message, a Uu signal strength has to be within a range from a minimal threshold to a maximal threshold (if provided by the network device).

A relay terminal is allowed to send a discovery message in any RRC status based on a NR sidelink communication configuration provided by the network device.

When a relay terminal supporting relay from a layer 3 (L3) terminal to a network device is connected to a network device that cannot perform a sidelink relay operation, the relay terminal is allowed to send a discovery message based on at least a preconfiguration when a serving carrier of the relay terminal does not double as a carrier for a sidelink operation.

A relay terminal supporting relay from a layer 2 (L2) terminal to a network device shall always be connected to a network device capable of performing a sidelink relay operation, including providing a configuration for transmitting a discovery message.

There are several cases as follows as to a remote terminal for relay between a terminal and a network device.

A remote terminal in an RRC idle status or an RRC inactive status is allowed to send a discovery message when a measured signal strength of a serving cell is lower than a configured threshold.

Whether a RRC connected remote terminal is allowed to transmit a discovery is up to a configuration provided by a serving network device. Details of the configuration provided by the serving network device may be discussed in a work item (WI).

Uu measurement by the remote terminal in the RRC idle status or the RRC inactive status requires no additional network configuration.

A remote terminal beyond coverage is always allowed to send a discovery message based on a preconfiguration in case the remote terminal is not connected to the network through a relay terminal.

When a remote terminal supporting relay from a terminal to network is connected directly to a network device that cannot perform a sidelink relay operation, the remote terminal is allowed to send a discovery message based on at least a preconfiguration when a serving carrier of the remote terminal does not double as a sidelink carrier.

For a remote terminal supporting relay from a L3 terminal to network for beyond-coverage indirect connection to a network device, it is unfeasible for the serving network device to provide a radio configuration for transmitting a discovery message.

Whether a remote terminal that supports relay from the L2 terminal to network and that is beyond coverage and connected indirectly to a network device is allowed to send a discovery message based on a configuration provided by the network device may be discussed in the WI.

A detailed definition of a network device that cannot perform a sidelink relay operation may be left to the WI, however shall include at least a case where the network device provides no sidelink relay configuration (has no discovery configuration, for example).

A resource pool for transmitting a discovery message may serve as a resource pool for data transmission, or may be discovery message dedicated.

For a shared resource pool and a discovery message dedicated resource pool, a new logical channel identification (LCID) is introduced for a discovery message. That is, the discovery message is carried by a new SL signalling radio bearer (SL SRB).

In the discovery message dedicated resource pool, discovery messages are treated equally in a logical channel processing (LCP) procedure.

### NR V2X

On an LTE V2X basis, NR V2X is further expanded from a broadcast scene to unicast and groupcast scenes, where V2X application is researched.

In NR V2X, similar to LTE V2X, the two resource grant modes may also be defined. Further, a user may be in a hybrid mode. Illustratively, a terminal may perform resource acquisition in mode 1, and may also perform resource acquisition in mode 2. The resource acquisition is indicated by sidelink grant. That is, the sidelink grant indicates time-frequency locations of corresponding physical sidelink control channel (PSCCH) and physical sidelink shared channel (PSSCH) resources.

In NR V2X, unlike LTE V2X, in addition to a terminal initiated hybrid automatic repeat request (HARQ) retransmission without feedback, a feedback based HARQ retransmission is introduced, which is not limited to unicast communication, but also includes groupcast communication.

In NR V2X, like LTE V2X, a dominating issue is data transmission latency instead of power efficiency, as an onboard system is powered continually. Therefore, the system design requires a terminal to perform continuous transmission and reception.

### NR V2X Logical Channel Prioritization

In related art, a logical channel priority is defined as follows.

A sidelink logical channel priority procedure may be applied when new transmission is performed.

Illustratively, RRC controls the scheduling of sidelink data by signalling for each logical channel:
sl-Priority, where an increasing priority value indicates a lower priority level;
sl-PrioritisedBitRate, which sets a sidelink prioritized bit rate (sPBR);
sl-BucketSizeDuration, which sets a sidelink bucket size duration (sBSD).

Illustratively, RRC additionally controls the LCP procedure by configuring mapping restrictions for each logical channel:
sl-configuredGrantType1Allowed, which sets whether a configured grant Type 1 can be used for sidelink transmission;
sl-AllowedCG-List, which sets the allowed configured grant(s) for sidelink transmission;
sl-HARQ-FeedbackEnabled, which sets whether the logical channel is allowed to be multiplexed with logical channel(s), with sl-HARQ-FeedbackEnabled set to enabled or disabled.

The following terminal variable is used for the logical channel prioritization procedure:
SBj, which is maintained for each logical channel j.

The MAC entity shall initialize SBj of a logical channel to zero when the logical channel is established.

For each logical channel j, the MAC entity shall:
increment SBj by the product sPBR×T before every instance of the LCP procedure, where T is the time elapsed since SBj was last incremented;
set SBj to the sidelink bucket size if the value of SBj is greater than the sidelink bucket size (i.e., sPBR×sBSD).

Illustratively, the exact moment(s) when the terminal updates SBj between LCP procedures is up to terminal implementation, as long as SBj is up to date at the time when a grant is processed by LCP.

In related art, logical channel selection is defined as follows.

The MAC entity shall for each sidelink control information (SCI) corresponding to a new transmission:
1> select a destination associated to one of unicast, groupcast (multicast) and broadcast, having at least one of MAC CE or the logical channel with the highest priority, among the logical channels that satisfy all the following conditions and MAC CE(s), if any, for the SL grant associated to the SCI:
SL data is available for transmission; and
SBj>0, in case there is any logical channel having SBj>0; and
sl-configuredGrantType1Allowed, if configured, is set to true in case the SL grant is a configured grant type 1; and
sl-AllowedCG-List, if configured, includes the configured grant index associated to the SL grant; and
sl-HARQ-FeedbackEnabled is set to disabled, if physical sidelink feedback channel (PSFCH) is not configured for the SL grant associated to the SCI.

Illustratively, if multiple destinations have the logical channels satisfying all the conditions above with the same highest priority, or if multiple destinations have the logical channels satisfying all the conditions above with the same priority as the MAC CE, which destination is selected among them is up to terminal implementation.
2> select the logical channels satisfying all the following conditions among the logical channels belonging to the selected destination:
SL data is available for transmission; and
sl-configuredGrantType1Allowed, if configured, is set to true in case the SL grant is a configured grant type 1; and
sl-AllowedCG-List, if configured, includes the configured grant index associated to the SL grant; and
if PSFCH is configured for the sidelink grant associated to the SCI:
sl-HARQ-FeedbackEnabled is set to enabled; or sl-HARQ-FeedbackEnabled is set to disabled.
3> else: sl-HARQ-FeedbackEnabled is set to disabled.

In related art, sidelink resource allocation is defined as follows.

The MAC entity shall for each SCI corresponding to a new transmission:
allocate resources to the logical channels as follows:

At operation 1, in logical channel selection, logical channels selected in the logical channel selection procedure for the SL grant with SBj>0 are allocated resources in a decreasing priority order. If the sPBR of a logical channel is set to infinity, the MAC entity shall allocate resources for all the data that is available for transmission on the logical channel before meeting the sPBR of the lower priority logical channel(s);

At operation 2, a terminal (an MAC entity) decrements SBj by the total size of MAC SDUs served to the logical channel j in the operation 1;

At operation 3, if any resources remain, all the logical channels selected in the logical channel selection procedure are served in a strict decreasing priority order (regardless of the value of SBj), until either the data for that logical channel or of the SL grant is exhausted, whichever comes first. Logical channels configured with equal priority should be served equally.

Illustratively, the value of SBj can be negative.

The terminal shall also follow rules below during the SL scheduling procedure above:
the terminal (the MAC entity) should not segment an RLC SDU (or partially transmitted SDU or retransmitted RLC PDU) if the whole SDU (or partially transmitted SDU or retransmitted RLC PDU) fits into the remaining resources of the associated MAC entity;
if the terminal (the MAC entity) segments an RLC SDU from the logical channel, the terminal shall maximize the size of the segment to fill the grant as much as possible;
the terminal (the MAC entity) should maximise data transmission;
if the terminal (the MAC entity) is given a terminal grant size that is equal to or greater than 12 bytes while having data available and allowed (according to logical channel selection) for transmission, the terminal (the MAC entity) shall not transmit only padding; and
a logical channel configured with sl-HARQ-FeedbackEnabled set to enabled and a logical channel configured with sl-HARQ-FeedbackEnabled set to disabled cannot be multiplexed into the same MAC PDU.

Illustratively, the MAC entity shall not generate a MAC PDU for the HARQ entity if the following conditions are satisfied:
there is no sidelink CSI reporting MAC CE generated for the PSSCH transmission; and
the MAC PDU includes zero MAC SDUs.

Illustratively, logical channels shsall be prioritised in the following order (the highest priority listed first):
data from SCCH;
sidelink CSI reporting MAC CE; and
data from any STCH.

FIG. 2 illustrates a flowchart of a method for prioritizing logical channels according to an illustrative embodiment of the disclosure. Embodiments of the disclosure are illustrated taking the method applying to the sidelink communication system illustrated in FIG. 1 as an example. The sidelink communication system includes the terminals and the network device. The method applies to a terminal. The method for prioritizing logical channels according to embodiments of the disclosure includes an operation as follows.

At operation 102, a terminal performs, based on a configuration of a transmission resource pool, logical channel prioritization on an available resource selected from the transmission resource pool.

The transmission resource pool includes at least one of: a resource pool configured for sending a discovery message for a sidelink, or a resource pool for sidelink data.

The transmission resource pool may be a resource pool configured by a network device for the terminal to acquire a resource to transmit data. In an embodiment, the resource pool for sending the discovery message for the sidelink is a resource pool dedicated to the discovery message.

Taking the transmission resource pool being the resource pool dedicated to the discovery message as an example, the terminal may select an available resource from the transmission resource pool as follows. The transmission resource pool may include multiple discovery messages. The terminal may monitor the transmission resource pool, such as by listen before talk (LBT). When it is detected that some discovery message is not in use, the terminal may select the discovery message as the available resource.

Illustratively, refer to foregoing content for the procedure of selecting an available resource by the terminal, which is not repeated.

The terminal may perform different logical channel prioritizations on selectable resources based on different configurations of the transmission resource pool.

In an embodiment, the configuration of the transmission resource pool may include at least one configuration as follows.

Configuration 1 of the transmission resource pool may include a first resource pool dedicated to the discovery message and a second resource pool for the sidelink data.

Configuration 2 of the transmission resource pool may include a third resource pool shared by the discovery message and the sidelink data.

Configuration 3 of the transmission resource pool may include a first abnormality resource pool dedicated to the discovery message or a second abnormality resource pool for the sidelink data.

Taking configuration 1 as an example, when the terminal is allowed to send the discovery message using the first resource pool, the terminal may select an available resource from the first resource pool, and perform logical channel prioritization.

The terminal may perform logical channel prioritization as follows. The terminal may select a first destination associated to the discovery message. The first destination may at least include a first logical channel and/or a media access control control element (MAC CE). There may be discovery message data to be transmitted from the first logical channel and/or the MAC CE. A group of logical channels or MAC CE(s) in the first destination may have a highest priority. Having determined the first destination, the terminal may select, from all logical channels within the first destination, a target logical channel satisfying a first condition. The first condition may include: there being the discovery message data to be transmitted.

For example, the terminal is required to select the first destination from three destinations. The three destinations each may include three groups of logical channels and MAC CEs.

In the first of the three destinations, a first group of logical channels and MAC CE(s) may have discovery message data to be transmitted; and among a third group of logical channels and MAC CE(s), a logical channel may have the highest priority. In the second of the three destinations, a second group of logical channels and MAC CE(s) may have discovery message data to be transmitted; and among a third group of logical channels and MAC CE(s), a logical channel may have the second highest priority. In the third of the three destinations, neither the three groups of logical channels nor the MAC CEs have discovery message data to be transmitted.

The terminal may exclude the third of the three selectable destinations first because the third destination has neither logical channel nor MAC CE that has discovery message data to be transmitted. The terminal may select the first of the three destinations as the first destination, as the logical channel in the third group of logical channels and MAC CE(s) in the first of the three destinations has the highest priority.

Taking configuration 3 as an example, when an abnormality condition is satisfied and the terminal is configured with the first abnormality resource pool, the terminal may select an available resource from the first abnormality resource pool, and perform logical channel prioritization. Refer to a foregoing example for the specific operations of the terminal in performing logical channel prioritization.

For example, the terminal may adopt mode-1 sidelink communication, and the abnormality condition may be start of a T316 timer. The T316 timer may indicate that the terminal sends radio link failure indication information to a master cell. As another example, the terminal may adopt mode-2 sidelink communication, and the abnormality condition may be a current monitoring result of the terminal being unavailable.

Having prioritized the logical channels, the terminal may select a target logical channel. Then, the terminal may perform sidelink resource allocation and data transmission based on the available resource, the target logical channel, and a group of logical channels or MAC CE(s) having the highest priority. Refer to foregoing content for the sidelink resource allocation, which is not repeated.

To sum up, with the method for prioritizing logical channels according to embodiments of the disclosure, a terminal may perform logical channel prioritization corresponding to different configurations of a transmission resource pool. The transmission resource pool may include a resource pool for sending sidelink data and/or a sidelink discovery message.

According to foregoing content, the terminal may perform different logical channel prioritization operations when the transmission resource pool has different configurations. Different logical channel prioritization operations performed based on three different configurations of the transmission resource pool are elaborated below.

### Configuration 1: The Transmission Resource Pool Includes a First Resource Pool Dedicated to the Discovery Message and a Second Resource Pool for the Sidelink Data.

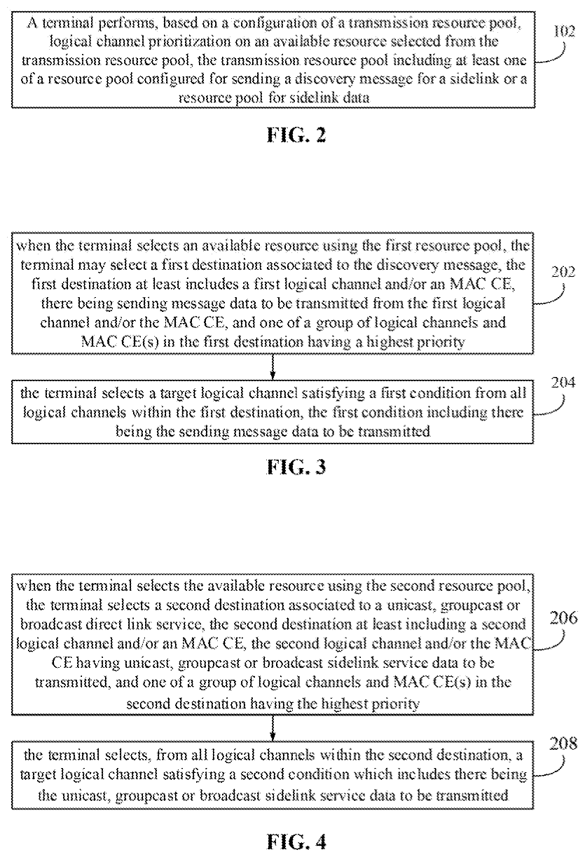

FIG. 3 illustrates a flowchart of a method for prioritizing logical channels according to an illustrative embodiment of the disclosure. Embodiments of the disclosure are illustrated taking the method applying to the sidelink communication system illustrated in FIG. 1 as an example. The sidelink communication system includes the terminals and the network device. The method applies to a terminal. The method for prioritizing logical channels according to embodiments of the disclosure may include operations as follows.

At operation 202, when the terminal selects an available resource using the first resource pool, the terminal may select a first destination associated to the discovery message.

Illustratively, the first destination may at least include a first logical channel and/or an media access control control element (MAC CE). There may be discovery message data to be transmitted from the first logical channel and/or the MAC CE. One of a group of logical channels and MAC CE(s) in the first destination may have a highest priority.

Refer to elaboration in the operation 102 for available resource selection, which is not repeated.

For example, the terminal is required to select the first destination from three destinations. The three destinations each may include three groups of logical channels and MAC CEs.

In the first of the three destinations, a first group of logical channels and MAC CE(s) may have discovery message data to be transmitted; and among a third group of logical channels and MAC CE(s), a logical channel may have the highest priority. In the second of the three destinations, a second group of logical channels and MAC CE(s) may have discovery message data to be transmitted; and among a third group of logical channels and MAC CE(s), a logical channel may have the second highest priority. In the third of the three destinations, neither the three groups of logical channels nor the MAC CEs have discovery message data to be transmitted.

The terminal may exclude the third of the three selectable destinations first because the third destination has neither logical channel or MAC CE that has discovery message data to be transmitted. The terminal may select the first of the three destinations as the first destination, as the logical channel in the third group of logical channels and MAC CE(s) in the first of the three destinations has the highest priority.

As another example, the terminal still is required to select the first destination from three destinations. The three destinations each may include three groups of logical channels and MAC CEs.

In the first of the three destinations, there may be no discovery message data to be transmitted from any of the three groups of logical channels and MAC CEs; and among a third group of logical channels and MAC CE(s), a logical channel may have the highest priority. In the second of the three destinations, there may be discovery message data to be transmitted from a second group of logical channel and an MAC CE, and among a third group of logical channels and MAC CE(s), a logical channel may have the second highest priority. In the third of the three destinations, there may be discovery message data to be transmitted from a first group of logical channels and MAC CE(s); and among a second group of logical channels and MAC CE(s), a logical channel may have a lowest priority.

The terminal may exclude the first of the three selectable destinations as no discovery message data is required to be transmitted from all logical channels and MAC CEs in the first of the three destinations. There are discovery message data to be transmitted from a respective group of logical channels and MAC CE(s) in each of the second and the third of the three destinations. The third logical channel in the second of the three destinations has a higher priority than the second group of logical channels in the third of the three destinations. Accordingly, the terminal may select the second of the three destinations as the first destination.

At operation 204, the terminal selects a target logical channel satisfying a first condition from all logical channels within the first destination.

The first condition may include: there being the discovery message data to be transmitted.

Having determined the first destination, the terminal is required to select a target logical channel from all logical channels within the first destination. The target logical channel is required to satisfy a first condition. In an embodiment, the target logical channel may be selected by an MAC entity.

For example, the first destination may include three groups of logical channels and MAC CEs. A first group of logical channels and MAC CE(s) may have discovery message data to be transmitted. A second group of logical channels and MAC CE(s) may have no discovery message data to be transmitted. A logical channel in a third group of logical channels and MAC CE(s) may have the highest priority. According to the first destination, the logical channel in the first group of logical channels and MAC CE(s) satisfies the first condition, and may be selected by the MAC entity as the target logical channel.

Having selected the target logical channel, the terminal may perform sidelink resource allocation and data transmission based on the available resource, the target logical channel, and a group of logical channels or MAC CE(s) having the highest priority. Refer to foregoing content for the sidelink resource allocation, which is not repeated.

Illustratively, in the operations 202 and 204, the terminal selects the available resource using the first resource pool and performs logical channel prioritization. In an embodiment, the terminal is not allowed to send the discovery message using the second resource pool in this case.

In another implementation, the terminal may select the available resource using the second resource pool and perform logical channel prioritization, specifically as illustrated in FIG. 4.

Illustratively, FIG. 4 illustrates a flowchart of a method for prioritizing logical channels according to an illustrative embodiment of the disclosure. Embodiments of the disclosure are illustrated taking the method applying to the sidelink communication system illustrated in FIG. 1 as an example. The sidelink communication system includes the terminals and the network device. The method applies to a terminal. The method for prioritizing logical channels according to embodiments of the disclosure may include operations as follows.

At operation 206, when the terminal selects the available resource using the second resource pool, the terminal selects a second destination associated to a unicast, groupcast or broadcast direct link service.

Illustratively, the second destination may at least include a second logical channel and/or an MAC CE. The second logical channel and/or the MAC CE has unicast, groupcast or broadcast sidelink service data to be transmitted. One of a group of logical channels and MAC CE(s) in the second destination may have the highest priority.

Refer to elaboration in the operation 102 for available resource selection, which is not repeated.

Refer to elaboration of the operation 202 specifically for the procedure of selecting the second destination by the terminal, which is similar to the procedure of selecting the first destination by the terminal, and is not repeated.

Illustratively, either one of (instead of both) the operations 202 and 206 is performed.

At operation 208, the terminal selects, from all logical channels within the second destination, a target logical channel satisfying a second condition.

The second condition may include: there being the unicast, groupcast or broadcast direct link service data to be transmitted.

Having determined the second destination, the terminal is required to select a target logical channel from all logical channels within the second destination. The target logical channel is required to satisfy a second condition. In an embodiment, the target logical channel may be selected by an MAC entity.

Having selected the target logical channel, the terminal may perform sidelink resource allocation and data transmission based on the available resource, the target logical channel, and a group of logical channels or MAC CE(s) having the highest priority. Refer to foregoing content for the sidelink resource allocation, which is not repeated.

In an embodiment, the second condition may further include that there is the discovery message data to be transmitted.

For example, the second destination may include three groups of logical channels and MAC CEs. There may be unicast, groupcast or broadcast direct link service data, as well as discovery message data, to be transmitted from a first group of logical channels and MAC CE(s). There may be no discovery message data to be transmitted from a second group of logical channels and MAC CE(s). Among a third group of logical channels and MAC CE(s), a logical channel may have the highest priority. According to the second destination, the logical channel in the first group of logical channels and MAC CE(s) satisfies the second condition, and may be selected by the MAC entity as the target logical channel.

As both the unicast, groupcast or broadcast direct link service data and the discovery message data is to be transmitted at the same time using the first group of logical channels and MAC CE(s), the terminal may transmit the unicast, groupcast or broadcast direct link service data and the discovery message data as a pack as long as the logical channel is capable of bearing the resources.

In an embodiment, a logical channel priority for the discovery message data may be reconfigured by a network device, or may be predefined, in a case that the second condition further includes that there is the discovery message data to be transmitted.

To sum up, embodiments of the disclosure describe different logical channel prioritization operations performed by the terminal when the transmission resource pool includes the first resource pool dedicated to the discovery message and the second resource pool for the sidelink data.

### Configuration 2: The Transmission Resource Pool Includes a Third Resource Pool Shared by the Discovery Message and the Sidelink Data.

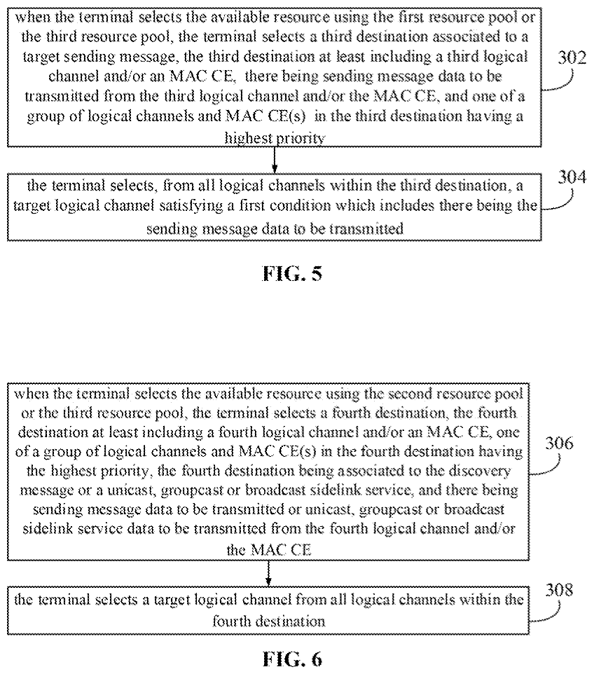

FIG. 5 illustrates a flowchart of a method for prioritizing logical channels according to an illustrative embodiment of the disclosure. Embodiments of the disclosure are illustrated taking the method applying to the sidelink communication system illustrated in FIG. 1 as an example. The sidelink communication system includes the terminals and the network device. The method applies to a terminal.

Illustratively, embodiments of the disclosure apply to configuration 1 as well. In configuration 1, the terminal is allowed to send the discovery message using both the first resource pool and the second resource pool. In configuration 2, the terminal is allowed to send the discovery message using the third resource pool. The method for prioritizing logical channels according to embodiments of the disclosure may include operations as follows.

At operation 302, when the terminal selects the available resource using the first resource pool or the third resource pool, the terminal selects a third destination associated to a target discovery message.

Illustratively, the third destination may at least include a third logical channel and/or a media access control control element (MAC CE). There may be discovery message data to be transmitted from the third logical channel and/or the MAC CE. One of a group of logical channels and MAC CE(s) in the third destination may have the highest priority.

Refer to elaboration in the operation 102 for available resource selection, which is not repeated.

Refer to elaboration of the operation 202 specifically for the procedure of selecting the third destination by the terminal, which is similar to the procedure of selecting the first destination by the terminal, and is not repeated.

At operation 304, the terminal selects, from all logical channels within the third destination, a target logical channel satisfying a first condition.

The first condition may include that there is the discovery message data to be transmitted.

Having determined the third destination, the terminal is required to select a target logical channel from all logical channels within the third destination. The target logical channel is required to satisfy the first condition. In an embodiment, the target logical channel may be selected by an MAC entity.

Refer to elaboration of the operation 204 for the procedure of selecting the target logical channel by the terminal, which is not repeated.

Having selected the target logical channel, the terminal may perform sidelink resource allocation and data transmission based on the available resource, the target logical channel, and a group of logical channels or MAC CE(s) having the highest priority. Refer to foregoing content for the sidelink resource allocation, which is not repeated.

Illustratively, in the operations 302 and 304, the terminal may select the available resource using the first resource pool or the third resource pool and perform logical channel prioritization. In an embodiment, the terminal is not allowed to send the discovery message using the second resource pool or the third resource pool in this case.

In another implementation, the terminal may select the available resource using the second resource pool or the third resource pool and perform logical channel prioritization, specifically as illustrated in FIG. 6.

Illustratively, FIG. 6 illustrates a flowchart of a method for prioritizing logical channels according to an illustrative embodiment of the disclosure. Embodiments of the disclosure are illustrated taking the method applying to the sidelink communication system illustrated in FIG. 1 as an example. The sidelink communication system includes the terminals and the network device. The method applies to a terminal. The method for prioritizing logical channels according to embodiments of the disclosure may include operations as follows.

At operation 306, when the terminal selects the available resource using the second resource pool or the third resource pool, the terminal selects a fourth destination.

Illustratively, the fourth destination may at least include a fourth logical channel and/or an MAC CE. One of an MAC CE and a group of logical channels in the fourth destination may have the highest priority. The fourth destination may be associated to the discovery message. Alternatively, the fourth destination may be associated to a unicast, groupcast or broadcast direct link service. There may be discovery message data to be transmitted from at least one of the fourth logical channel or the MAC CE. Alternatively, there may be unicast, groupcast or broadcast direct link service data to be transmitted from at least one of the fourth logical channel or the MAC CE.

Refer to elaboration in the operation 102 for available resource selection, which is not repeated.

Refer to elaboration of the operation 302 specifically for the procedure of selecting the fourth destination by the terminal, which is similar to the procedure of selecting the third destination by the terminal, and is not repeated.

Illustratively, either one of (instead of both) the operations 302 and 306 is performed.

At operation 308, the terminal selects a target logical channel from all logical channels within the fourth destination.

Having determined the fourth destination, the terminal is required to select a target logical channel from all logical channels within the fourth destination. In an embodiment, the target logical channel may be selected by an MAC entity.

Refer to elaboration of the operation 204 for the procedure of selecting the target logical channel by the terminal, which is not repeated.

Having selected the target logical channel, the terminal may perform sidelink resource allocation and data transmission based on the available resource, the target logical channel, and a group of logical channels or MAC CE(s) having the highest priority. Refer to foregoing content for the sidelink resource allocation, which is not repeated.

The target logical channel is required to satisfy different conditions, depending on a basis on which the fourth destination is selected. Embodiments of the disclosure describe two different bases on which the fourth destination is selected.

With a first basis, a fourth destination is selected based on a logical channel which has the discovery message data to be transmitted.

The operation 308 may be implemented as follows.

The terminal may select a target logical channel satisfying a third condition from all the logical channels within the fourth destination. The third condition may include that there is discovery message data to be transmitted.

Refer to elaboration of the operation 204 for the procedure of selecting the target logical channel by the terminal, which is not repeated.

In an embodiment, the third condition may further include that there is the unicast, groupcast or broadcast direct link service data to be transmitted.

In an embodiment, a logical channel priority for the discovery message data may be reconfigured by a network device, or may be predefined, in a case where the third condition further includes that there is the unicast, groupcast or broadcast direct link service data to be transmitted.

With a second basis, a fourth destination is selected based on a logical channel which has the unicast, groupcast or broadcast direct link service data to be transmitted.

The operation 308 may be implemented as follows.

The terminal may select a target logical channel satisfying a fourth condition from all the logical channels within the fourth destination. The fourth condition may include that there is the unicast, groupcast or broadcast direct link service data to be transmitted.

Refer to elaboration of the operation 204 for the procedure of selecting the target logical channel by the terminal, which is not repeated.

In an embodiment, the fourth condition may further include that there is the discovery message data to be transmitted.

In an embodiment, a logical channel priority for the discovery message data may be reconfigured by a network device, or may be predefined, in a case where the fourth condition further includes that there is the discovery message data to be transmitted.

To sum up, embodiments of the disclosure describe different logical channel prioritization operations performed by the terminal in a case where the transmission resource pool includes the first resource pool dedicated to the discovery message and the second resource pool for the sidelink data, or the transmission resource pool includes the third resource pool shared by the discovery message and the sidelink data.

### Configuration 3: The Transmission Resource Pool Includes a First Abnormality Resource Pool Dedicated to the Discovery Message or a Second Abnormality Resource Pool for the Sidelink Data.

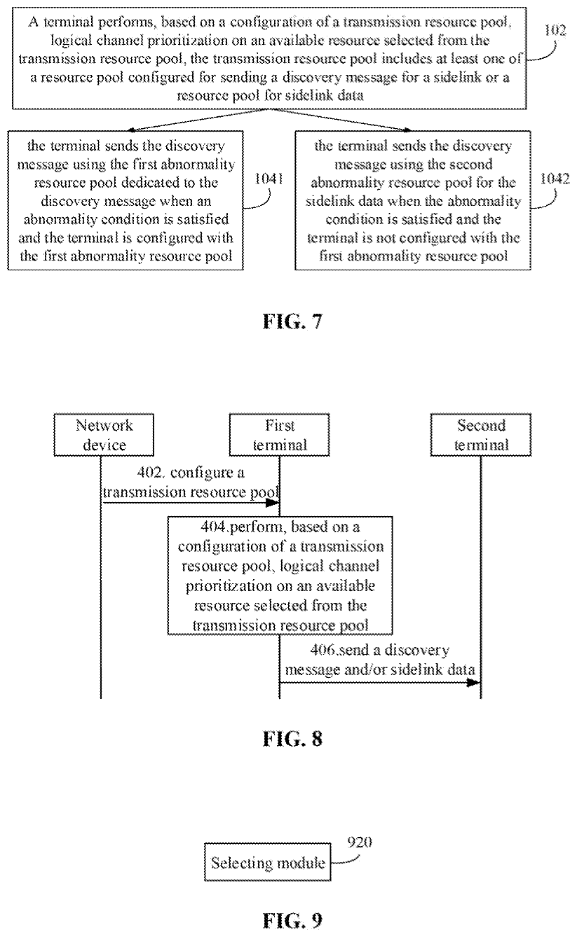

FIG. 7 illustrates a flowchart of a method for prioritizing logical channels according to an illustrative embodiment of the disclosure. Embodiments of the disclosure are illustrated taking the method applying to the sidelink communication system illustrated in FIG. 1 as an example. The sidelink communication system includes the terminals and the network device. The method applies to a terminal. The method for prioritizing logical channels according to embodiments of the disclosure may include operations as follows.

At operation 102, a terminal performs, based on a configuration of a transmission resource pool, logical channel prioritization on an available resource selected from the transmission resource pool.

The transmission resource pool may include at least one of: a resource pool configured for sending a discovery message for a sidelink, or a resource pool for sidelink data.

Illustratively, refer to foregoing content for the transmission resource pool and the available resource, which is not repeated.

In an embodiment, the terminal may perform operations 1041 or 1042 in a case wherein the transmission resource pool includes the first abnormality resource pool dedicated to the discovery message or the second abnormality resource pool for the sidelink data. The operations 1041 and 1042 are specifically as follows.

At the operation 1041, the terminal sends the discovery message using the first abnormality resource pool dedicated to the discovery message when an abnormality condition is satisfied and the terminal is configured with the first abnormality resource pool.

At the operation 1042, the terminal sends the discovery message using the second abnormality resource pool for the sidelink data when the abnormality condition is satisfied and the terminal is not configured with the first abnormality resource pool.

The terminal may send the discovery message using the first abnormality resource pool or the second abnormality resource pool as follows. The terminal may select an available resource from the first abnormality resource pool or the second abnormality resource pool, and perform logical channel prioritization. Refer to foregoing content for the specific operations in performing logical channel prioritization, which is not repeated.

Having prioritized the logical channels, the terminal may select a target logical channel. Then, the terminal may perform sidelink resource allocation and data transmission based on the available resource, the target logical channel, and a group of logical channels or MAC CE(s) having the highest priority. Refer to foregoing content for the sidelink resource allocation, which is not repeated.

The abnormality condition may differ for different communication modes adopted by the terminal.

According to foregoing content, the terminal may adopt mode-1 or mode-2 sidelink communication.

In an embodiment, the terminal may adopt mode-1 sidelink communication. The abnormality condition may include at least one of the following.

The abnormality condition may include start of a T311 timer or a T310 timer of a master cell group (MCG). The T310 timer may indicate that the terminal fails in radio link monitoring. The T311 timer may indicate that the terminal is waiting for a radio resource control (RRC) re-establishment response.

The abnormality condition may include start of a T316 timer. The T316 timer may indicate that the terminal sends radio link failure indication information to a master cell.

The abnormality condition may include start of a T304 timer of the MCG, and configuration of the first abnormality resource pool or the second abnormality resource pool through specific signalling. The T304 timer may indicate retransmission capability information of the terminal.

In an embodiment, the terminal may adopt mode-2 sidelink communication.

The abnormality condition may include a current monitoring result to the terminal being unavailable.

For example, the terminal may adopt mode-1 sidelink communication. T316 timer may be started. The terminal may be configured with the first abnormality resource pool. The terminal may send the discovery message using the first abnormality resource pool. As another example, the terminal may adopt mode-2 sidelink communication, the current monitoring result is unavailable to the terminal, and the terminal is not configured with the first abnormality resource pool. The terminal may send the discovery message using the second abnormality resource pool.

To sum up, embodiments of the disclosure describe different logical channel prioritization operations performed by the terminal in a case where the transmission resource pool includes the first abnormality resource pool dedicated to the discovery message or the second abnormality resource pool for the sidelink data.

FIG. 8 illustrates a diagram of multi-end interaction in a method for prioritizing logical channels according to an illustrative embodiment of the disclosure. Embodiments of the disclosure are illustrated taking the method applying to the sidelink communication system illustrated in FIG. 1 as an example. The method for prioritizing logical channels according to embodiments of the disclosure may include operations as follows.

At operation 402, a network device may configure a transmission resource pool for a first terminal.

A transmission resource pool may be configured for a terminal to acquire a resource to transmit data. Illustratively, the transmission resource pool may include at least one of a resource pool configured for sending a discovery message for a sidelink or a resource pool for sidelink data.

According to foregoing content, the configuration of the transmission resource pool may include at least one configuration as follows.

Configuration 1 is that the transmission resource pool includes a first resource pool dedicated to the discovery message and a second resource pool for the sidelink data.

Configuration 2 is that the transmission resource pool includes a third resource pool shared by the discovery message and the sidelink data.

Configuration 3 is that the transmission resource pool includes a first abnormality resource pool dedicated to the discovery message or a second abnormality resource pool for the sidelink data.

At operation 404, the first terminal performs, based on a configuration of the transmission resource pool, logical channel prioritization on an available resource selected from the transmission resource pool.

Refer to foregoing content for the procedure of selecting the available resource by the first terminal, which is not repeated.

Illustratively, refer to elaboration of the operation 102 or elaboration of logical channel prioritization illustrated in any one of FIG. 3 to FIG. 7 for the operation 404, which is not repeated.

For example, refer to elaboration of the operations 202 and 204, or elaboration of the operations 206 and 208, or elaboration of the operations 304 and 306, or elaboration of the operations 306 and 308 for the logical channel prioritization operations performed by the first terminal, in a case where the transmission resource pool includes the first resource pool dedicated to the discovery message and the second resource pool for the sidelink data.

As another example, refer to elaboration of the operations 302 and 304 or elaboration of the operations 306 and 308 for the logical channel prioritization operations performed by the first terminal, in a case where the transmission resource pool includes the third resource pool shared by the discovery message and the sidelink data.

As another example, refer to elaboration of the operations 1041 and 1042 for the logical channel prioritization operation performed by the first terminal, in a case where the transmission resource pool includes the first abnormality resource pool dedicated to the discovery message or the second abnormality resource pool for the sidelink data.

At operation 406, the first terminal sends a discovery message and/or sidelink data to a second terminal.

Having prioritized the logical channels, the first terminal may select a target logical channel. Then, the first terminal may allocate the discovery message and/or the sidelink data based on the available resource, the target logical channel, and a group of logical channels or MAC CE(s) having the highest priority, and transmit the discovery message and/or the sidelink data to the second terminal.

Refer to foregoing content for the sidelink resource allocation, which is not repeated.

Illustratively, three different implementations of the method for prioritizing logical channels are given below based on different transmission resource pools configured by the network device for the first terminal.

In a first implementation, the network device configures, for the first terminal, both the first resource pool dedicated to the discovery message and the second resource pool for the sidelink data.

In an implementation, the first terminal is not allowed to send the discovery message using the second resource pool.

Illustratively, the first terminal may select an available resource using the first resource pool. Then, the first terminal may perform logical channel prioritization as follows.

In operation 1, the first terminal selects a first destination associated to transmission of the discovery message.

The first destination may at least include an MAC CE and/or a group of logical channels satisfying a condition of having discovery message data to be transmitted. Meanwhile, the group of logical channels or the MAC CE in the first destination may have the highest priority.

In operation 2, after completion of destination selection, an MAC entity of the first terminal is required to select, from all logical channels included in the first destination, a target logical channel satisfying a first condition of having the discovery message data to be transmitted.

Illustratively, the first terminal may select an available resource using the second resource pool. Then, the first terminal may perform logical channel prioritization as follows.

In operation 1, the first terminal selects a second destination associated to the unicast, groupcast or broadcast direct link service.

The second destination may at least include an MAC CE and/or a group of logical channels satisfying a condition of having the unicast, groupcast, or broadcast direct link service data to be transmitted. Meanwhile, the group of logical channels or the MAC CE in the second destination may have the highest priority.

In operation 2, after completion of destination selection, the MAC entity of the first terminal is required to select, from all logical channels included in the second destination, a target logical channel satisfying a second condition of having the unicast, groupcast, or broadcast direct link service data to be transmitted.

In an embodiment, the second condition may further include that there is discovery message data to be transmitted. In an embodiment, a logical channel priority for the discovery message data may be reconfigured by a base station, or may be predefined.

In another implementation, the first terminal is allowed to send the discovery message using both the first resource pool and the second resource pool.

Illustratively, the first terminal may select an available resource using the first resource pool. Then, the first terminal may perform logical channel prioritization as follows.

In operation 1, the first terminal may select a third destination associated to transmission of the discovery message.

The third destination may at least include an MAC CE and/or a group of logical channels satisfying a condition of having the discovery message data to be transmitted. Meanwhile, the group of logical channels or the MAC CE in the third destination may have the highest priority.

In operation 2, after completion of destination selection, the MAC entity of the first terminal is required to select, from all logical channels included in the third destination, a target logical channel satisfying a first condition of having the discovery message data to be transmitted.

Illustratively, the first terminal may select an available resource using the second resource pool. Then, the first terminal may perform logical channel prioritization as follows.

In operation 1, the first terminal selects a fourth destination associated to transmission of the discovery message or the unicast, groupcast or broadcast direct link service.

The fourth destination may at least include an MAC CE and/or a group of logical channels satisfying a condition of having the discovery message data or the unicast, groupcast or broadcast direct link service data to be transmitted. Meanwhile, the group of logical channels or the MAC CE in the fourth destination may have the highest priority.

In operation 2, after completion of destination selection, the MAC entity of the first terminal is required to select a target logical channel from all logical channels included in the fourth destination.

In an embodiment, operation 2 may be implemented in two modes as follows, depending on a basis on which the fourth destination is selected.

In optional mode 1, if a fourth destination is selected based on a logical channel which has the discovery message data to be transmitted, the MAC entity of the first terminal is required to select, from all logical channels included in the fourth destination, a logical channel satisfying a third condition which is there being discovery message data to be transmitted.

In an embodiment, the third condition may further include that there is the unicast, groupcast or broadcast direct link service data to be transmitted. In an embodiment, a logical channel priority for the unicast, groupcast or broadcast direct link service data may be reconfigured by a base station, or may be predefined.

In optional mode 2, if the destination is selected based on a logical channel which has the unicast, groupcast or broadcast direct link service data to be transmitted, the MAC entity of the first terminal is required to select, from all the logical channels included in the fourth destination, a logical channel satisfying a fourth condition that there is the unicast, groupcast or broadcast direct link service data to be transmitted.

In an embodiment, the fourth condition may further include that there is the discovery message data to be transmitted. Further, a logical channel priority for the discovery message data may be reconfigured by a base station, or may be predefined.

In a second implementation, the network device configures, for the first terminal, the third resource pool shared by the discovery message and the sidelink data.

Illustratively, the first terminal may select an available resource using the first resource pool. Then, the first terminal may perform logical channel prioritization as follows.

In operation 1, the first terminal may select a third destination associated to transmission of the discovery message.

The third destination may at least include an MAC CE and/or a group of logical channels satisfying a condition of having the discovery message data to be transmitted. Meanwhile, the group of logical channels or the MAC CE in the third destination may have the highest priority.

In operation 2, after completion of destination selection, the MAC entity of the first terminal is required to select, from all logical channels included in the third destination, a target logical channel satisfying a first condition of having the discovery message data to be transmitted.

Illustratively, the first terminal may select an available resource using the second resource pool. Then, the first terminal may perform logical channel prioritization as follows.

In operation 1, the first terminal selects a fourth destination associated to the transmission of the discovery message or the unicast, groupcast or broadcast direct link service.

The fourth destination may at least include an MAC CE and/or a group of logical channels satisfying a condition of having the discovery message data or the unicast, groupcast or broadcast direct link service data to be transmitted. Meanwhile, the group of logical channels or the MAC CE in the fourth destination may have the highest priority.

In operation 2, after completion of destination selection, the MAC entity of the first terminal is required to select a target logical channel from all logical channels included in the fourth destination.

In an embodiment, operation 2 may be implemented in two modes as follows, depending on a basis on which the fourth destination is selected.

In optional mode 1, if a fourth destination is selected based on a logical channel which has the discovery message data to be transmitted, the MAC entity of the first terminal is required to select, from all logical channels included in the fourth destination, a logical channel satisfying a third condition which is there being discovery message data to be transmitted.

In an embodiment, the third condition may further include that there is the unicast, groupcast or broadcast direct link service data to be transmitted. In an embodiment, a logical channel priority for the unicast, groupcast or broadcast direct link service data may be reconfigured by a base station, or may be predefined.

In optional mode 2, if the destination is selected based on a logical channel which has the unicast, groupcast or broadcast direct link service data to be transmitted, the MAC entity of the first terminal is required to select, from all the logical channels included in the fourth destination, a logical channel satisfying a fourth condition that there is the unicast, groupcast or broadcast direct link service data to be transmitted.

In an embodiment, the fourth condition may further include that there is the discovery message data to be transmitted. Further, a logical channel priority for the discovery message data may be reconfigured by a base station, or may be predefined.

In a third implementation, the network device configures, for the first terminal, the first abnormality resource pool dedicated to the discovery message or the second abnormality resource pool for the sidelink data.

Illustratively, in a case where the abnormality condition is met, the first terminal may send the discovery message using the first abnormality resource pool when the first terminal is configured with the first abnormality resource pool, or send the discovery message using the second abnormality resource pool when the first terminal is not configured with the first abnormality resource pool.

The abnormality condition may vary, depending on a mode of sidelink communication adopted by the first terminal.

In an embodiment, the terminal may adopt mode-1 sidelink communication. The abnormality condition may include at least one of: start of a T311 timer or a T310 timer of a master cell group (MCG); start of a T316 timer; start of a T301 timer; or start of a T304 timer of the MCG, and configuration of the first abnormality resource pool or the second abnormality resource pool through specific signalling.

In an embodiment, the terminal may adopt mode-2 sidelink communication. The abnormality condition may include: a current monitoring result of the first terminal being unavailable.

To sum up, embodiments of the disclosure describe a diagram of multi-end interaction in a method for prioritizing logical channels. Meanwhile, embodiments of the disclosure describe three different logical channel prioritization operations based on different transmission resource pools configured by the network device for the first terminal.

The following are apparatus embodiments of the disclosure. Refer to corresponding description in a method embodiment for any detail not elaborated in an apparatus embodiment, which is not repeated in the disclosure.

FIG. 9 is a diagram of an apparatus for prioritizing logical channels according to an illustrative embodiment of the disclosure. The apparatus includes a selecting module.

The selecting module 920 is configured to perform, based on a configuration of a transmission resource pool, logical channel prioritization on an available resource selected from the transmission resource pool.

The transmission resource pool may include at least one of: a resource pool configured for sending a discovery message for a sidelink, or a resource pool for sidelink data.

In an embodiment, the configuration of the transmission resource pool may include a first resource pool dedicated to the discovery message and a second resource pool for the sidelink data. The selecting module 920 may be configured to select a first destination associated to the discovery message when the available resource is selected using the first resource pool. The first destination may at least include a first logical channel and/or a media access control control element (MAC CE). There may be discovery message data to be transmitted from the first logical channel and/or the MAC CE. One of a group of logical channels and MAC CE(s) in the first destination may have a highest priority. The selecting module may be configured to select, from all logical channels within the first destination, a target logical channel satisfying a first condition. The first condition may include that there is the discovery message data to be transmitted.

In an embodiment, the selecting module 920 is further configured to select a second destination associated to a unicast, groupcast or broadcast direct link service when the available resource is selected using the second resource pool. The second destination may at least include a second logical channel and/or an MAC CE. There may be unicast, groupcast or broadcast direct link service data to be transmitted from the second logical channel and/or the MAC CE. One of a group of logical channels and MAC CE(s) in the second destination may have the highest priority. The selecting module may be further configured to select, from all logical channels within the second destination, a target logical channel satisfying a second condition. The second condition may include that there is the unicast, groupcast or broadcast direct link service data to be transmitted.

In an embodiment, the second condition may further include that there is the discovery message data to be transmitted.

In an embodiment, a logical channel priority for the discovery message data may be reconfigured by a network device, or may be predefined.

In an embodiment, the configuration of the transmission resource pool may include a first resource pool dedicated to the discovery message and a second resource pool for the sidelink data, or the configuration of the transmission resource pool may include a third resource pool shared by the discovery message and the sidelink data. The selecting module 920 may be configured to select a third destination associated to a target discovery message when the available resource is selected using the first resource pool or the third resource pool. The third destination may at least include a third logical channel and/or a media access control control element (MAC CE). There may be discovery message data to be transmitted from the third logical channel and/or an MAC CE. One of a group of logical channels and MAC CE(s) in the third destination may have a highest priority. The selecting module may be configured to select, from all logical channels within the third destination, a target logical channel satisfying a first condition. The first condition may include that there is the discovery message data to be transmitted.

In an embodiment, the selecting module 920 is further configured to select a fourth destination when the available resource is selected using the second resource pool or the third resource pool. The fourth destination may at least include a fourth logical channel and/or an MAC CE. One of an MAC CE and a group of logical channels in the fourth destination may have the highest priority. The fourth destination may be associated to the discovery message, or the fourth destination may be associated to a unicast, groupcast or broadcast direct link service. There may be discovery message data to be transmitted from at least one of the fourth logical channel or the MAC CE, or there may be unicast, groupcast or broadcast direct link service data to be transmitted from at least one of the fourth logical channel or the MAC CE. The selecting module may be further configured to select a target logical channel from all logical channels within the fourth destination.

In an embodiment, the fourth destination may be selected based on a logical channel which has the discovery message data to be transmitted. The selecting module 920 may be configured to select, from all the logical channels within the fourth destination, a target logical channel satisfying a third condition. The third condition may include that there is discovery message data to be transmitted.

In an embodiment, the third condition may further include that there is the unicast, groupcast or broadcast direct link service data to be transmitted.

In an embodiment, a logical channel priority for the unicast, groupcast or broadcast direct link service data may be reconfigured by a network device, or may be predefined.

In an embodiment, the fourth destination may be selected based on a logical channel which has the unicast, groupcast or broadcast direct link service data to be transmitted. The selecting module 920 may be configured to select, from all the logical channels within the fourth destination, a target logical channel satisfying a fourth condition. The fourth condition may include that there is the unicast, groupcast or broadcast direct link service data to be transmitted.

In an embodiment, the fourth condition may further include that there is the discovery message data to be transmitted.

In an embodiment, a logical channel priority for the discovery message data may be reconfigured by the network device, or may be predefined.

In an embodiment, the selecting module 920 is further configured to send the discovery message using a first abnormality resource pool dedicated to the discovery message when an abnormality condition is satisfied and the terminal is configured with the first abnormality resource pool; and send the discovery message using a second abnormality resource pool for the sidelink data when the abnormality condition is satisfied and the terminal is not configured with the first abnormality resource pool.

In an embodiment, the abnormality condition may include at least one of: start of a T311 timer or a T310 timer of a master cell group (MCG), the T310 timer indicating that the terminal fails in radio link monitoring, the T311 timer indicating that the terminal is waiting for a radio resource control (RRC) re-establishment response; start of a T316 timer, the T316 timer indicating that the terminal sends a radio link failure indication information to a master cell; or start of a T304 timer of the MCG, and configuration of the first abnormality resource pool or the second abnormality resource pool through specific signalling. The T304 timer may indicate retransmission capability information of the terminal.

In an embodiment, the abnormality condition may include a current monitoring result of the terminal being unavailable.

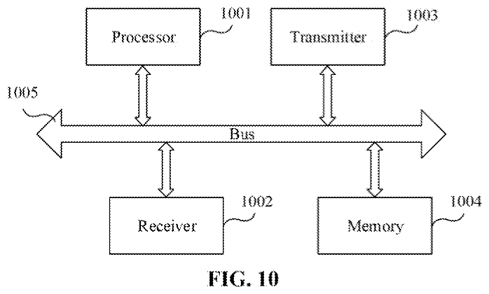

FIG. 10 illustrates a diagram of a structure of a communication device (terminal or network device) according to an illustrative embodiment of the disclosure. The communication device includes a processor 1001, a receiver 1002, a transmitter 1003, a memory 1004, and a bus 1005.

The processor 1001 may include one or more processing cores. The processor 1001 may implement various functional applications and information processing by executing software programs and modules.

The receiver 1002 and the transmitter 1003 may be implemented as one communication component. The communication component may be a communication chip.

The memory 1004 may be connected to the processor 1001 via the bus 1005.

The memory 1004 may be configured to store at least one instruction. The processor 1001 may be configured to execute the at least one instruction to implement the steps of in method embodiments described here.

Further, the memory 1004 may be implemented by any type of volatile or non-volatile storage equipment, or a combination of the any listed item. The volatile or non-volatile memory includes, but is not limited to, a magnetic disk or an optical disk, electrically-erasable programmable read only memory (EEPROM), erasable programmable read only memory (EPROM), static random access memory (SRAM), read-only memory (ROM), magnetic memory, flash memory, programmable read-only memory (PROM), etc.

Embodiments of the disclosure further provide a terminal. The terminal includes a processor. The processor is configured to perform, based on a configuration of a transmission resource pool, logical channel prioritization on an available resource selected from the transmission resource pool. The transmission resource pool may include at least one of a resource pool configured for sending a discovery message for a sidelink or a resource pool for sidelink data.

Embodiments of the disclosure further provide a computer-readable storage medium. The storage medium has stored thereon a computer program. The computer program is configured to be executed by a processor to implement a foregoing method for prioritizing logical channels.

Embodiments of the disclosure further provide a chip. The chip includes at least one of a programmable logic circuit or program instructions configured to implement a foregoing method for prioritizing logical channels when the chip runs.

Embodiments of the disclosure further provide a computer program product or a computer program. The computer program product or the computer program includes computer instructions stored in a computer-readable storage medium which, when read and executed by a processor, implement a foregoing method for prioritizing logical channels.

What described are just embodiments of the disclosure and are not intended to limit the disclosure. Any modification, equivalent replacement, improvement, and/or the like made within the spirit and principle of the disclosure shall be included in the scope of the disclosure.

1. A method for prioritizing logical channels, comprising:
performing, by a terminal based on a configuration of a transmission resource pool, logical channel prioritization on an available resource selected from the transmission resource pool,
wherein the transmission resource pool comprises at least one of: a resource pool configured for sending a discovery message for a sidelink, or a resource pool for sidelink data.

2. The method of claim 1, wherein the configuration of the transmission resource pool comprises a first resource pool dedicated to the discovery message and a second resource pool for the sidelink data,
wherein performing, by the terminal based on the configuration of the transmission resource pool, logical channel prioritization on the available resource selected from the transmission resource pool comprises:
selecting, by the terminal, a first destination associated to the discovery message in response to selecting the available resource by the terminal from the first resource pool, wherein the first destination at least comprises at least one of a first logical channel or a media access control control element (MAC CE), wherein there is discovery message data to be transmitted from at least one of the first logical channel or the MAC CE, wherein one of the MAC CE and a group of logical channels in the first destination has a highest priority; and
selecting, by the terminal, a target logical channel satisfying a first condition from all logical channels within the first destination,
wherein the first condition comprises: there being the discovery message data to be transmitted.

3. The method of claim 2, wherein performing, by the terminal based on the configuration of the transmission resource pool, logical channel prioritization on the available resource selected from the transmission resource pool further comprises:
selecting, by the terminal, a second destination associated to a unicast, groupcast or broadcast direct link service in response to that selecting the available resource by the terminal from the second resource pool, wherein the second destination at least comprises at least one of a second logical channel or an MAC CE, wherein there is unicast, groupcast or broadcast direct link service data to be transmitted from at least one of the second logical channel or the MAC CE, wherein one of the MAC CE and a group of logical channels in the second destination has the highest priority; and
selecting, by the terminal, a target logical channel satisfying a second condition from all logical channels within the second destination,
wherein the second condition comprises: there being the unicast, groupcast or broadcast direct link service data to be transmitted.

4. The method of claim 3, wherein the second condition further comprises:
there being the discovery message data to be transmitted.

5. The method of claim 4, wherein a logical channel priority for the discovery message data is reconfigured by a network device, or is predefined.

6. The method of claim 1, wherein the configuration of the transmission resource pool comprises a first resource pool dedicated to the discovery message and a second resource pool for the sidelink data, or the configuration of the transmission resource pool comprises a third resource pool shared by the discovery message and the sidelink data,
wherein performing, by the terminal based on the configuration of the transmission resource pool, logical channel prioritization on the available resource selected from the transmission resource pool comprises:
selecting, by the terminal, a third destination associated to a target discovery message in response to selecting the available resource by the terminal from the first resource pool or the third resource pool, wherein the third destination at least comprises at least one of a third logical channel or a media access control control element (MAC CE), wherein there is discovery message data to be transmitted from at least one of the third logical channel or the MAC CE, wherein one of the MAC CE and a group of logical channels in the third destination has a highest priority; and
selecting, by the terminal, a target logical channel satisfying a first condition from all logical channels within the third destination,
wherein the first condition comprises: there being the discovery message data to be transmitted.

7. The method of claim 6, wherein performing, by the terminal based on the configuration of the transmission resource pool, logical channel prioritization on the available resource selected from the transmission resource pool further comprises:
selecting, by the terminal, a fourth destination in response to selecting the available resource by the terminal from the second resource pool or the third resource pool, wherein the fourth destination at least comprises at least one of a fourth logical channel or an MAC CE, wherein one of the MAC CE and a group of logical channels in the fourth destination has the highest priority, wherein the fourth destination is associated to the discovery message, or the fourth destination is associated to a unicast, groupcast or broadcast direct link service, wherein there is discovery message data to be transmitted from at least one of the fourth logical channel or the MAC CE, or there is unicast, groupcast or broadcast direct link service data to be transmitted from at least one of the fourth logical channel or the MAC CE; and
selecting, by the terminal, a target logical channel from all logical channels within the fourth destination.

8. The method of claim 7, wherein the fourth destination is selected based on a logical channel with the discovery message data to be transmitted,
wherein selecting, by the terminal, the target logical channel from all the logical channels within the fourth destination comprises:
selecting, by the terminal, the target logical channel satisfying a third condition from all the logical channels within the fourth destination,
wherein the third condition comprises: there being the discovery message data to be transmitted.

9. The method of claim 8, wherein the third condition further comprises:
there being the unicast, groupcast or broadcast direct link service data to be transmitted.

10. The method of claim 9, wherein a logical channel priority for the unicast, groupcast or broadcast direct link service data is reconfigured by a network device, or is predefined.

11. The method of claim 7, wherein the fourth destination is selected based on a logical channel with the unicast, groupcast or broadcast direct link service data to be transmitted,
wherein selecting, by the terminal, the target logical channel from all the logical channels within the fourth destination comprises:
selecting, by the terminal, the target logical channel satisfying a fourth condition from all the logical channels within the fourth destination,
wherein the fourth condition comprises: there being the unicast, groupcast or broadcast direct link service data to be transmitted.

12. The method of claim 10, wherein the fourth condition further comprises:
there being the discovery message data to be transmitted.

13. The method of claim 12, wherein a logical channel priority for the discovery message data is reconfigured by the network device, or is predefined.

14. The method of claim 1, further comprising:
sending, by the terminal, the discovery message using a first abnormality resource pool dedicated to the discovery message in response to an abnormality condition being satisfied and the terminal being configured with the first abnormality resource pool; and
sending, by the terminal, the discovery message using a second abnormality resource pool for the sidelink data in response to the abnormality condition being satisfied and the terminal being not configured with the first abnormality resource pool.

15. The method of claim 14, wherein the terminal adopts mode-1 sidelink communication, and the abnormality condition comprises at least one of:
start of a T311 timer or a T310 timer of a master cell group (MCG), wherein the T310 timer is configured to indicate that the terminal fails in radio link monitoring, and the T311 timer is configured to indicate that the terminal is waiting for a radio resource control (RRC) re-establishment response;
start of a T316 timer, wherein the T316 timer is configured to indicate that the terminal sends radio link failure indication information to a master cell; or
start of a T304 timer of the MCG, and configuration of the first abnormality resource pool or the second abnormality resource pool through specific signalling, wherein the T304 timer is configured to indicate a retransmission capability information of the terminal.

16. The method of claim 14, wherein the terminal adopts mode-2 sidelink communication, and the abnormality condition comprises:
a current monitoring result of the terminal being unavailable.

17. A terminal, comprising a processor,
wherein the processor is configured to perform, based on a configuration of a transmission resource pool, logical channel prioritization on an available resource selected from the transmission resource pool,
wherein the transmission resource pool comprises at least one of: a resource pool configured for sending a discovery message for a sidelink, or a resource pool for sidelink data.

18. A non-transitory computer-readable storage medium, having stored thereon a computer program configured to be executed by a processor to implement the method of claim 1.

19. A chip, comprising at least one of a programmable logic circuit or program instructions configured to implement the method of claim 1 when the chip runs.
